(19) United States
(12) Patent Application Publication
(10) Pub. No.: US 2026/0329798 A1
(43) Pub. Date: Oct. 22, 2026

(54) OFF-CHIP DRIVER AND MEMORY CHIP

(71) Applicant: NANYA TECHNOLOGY CORPORATION, New Taipei City (TW)

(72) Inventor: Chang-Ting Wu, New Taipei City (TW)

(73) Assignee: NANYA TECHNOLOGY CORPORATION, New Taipei City (TW)

(21) Appl. No.: 19/185,290

(22) Filed: Apr. 22, 2025

(51) Int. Cl. G06F 13/40

(52) U.S. Cl. CPC G06F 13/4086

(57) ABSTRACT

An off-chip driver (OCD) comprises a first driver circuit. The first driver circuit comprises a first impedance circuit and a plurality of first driver units. The first impedance circuit is coupled to a signal pad. The first impedance circuit comprises a first metal-oxide-silicon (MOS) transistor and a second MOS transistor. The first MOS transistor has a drain terminal coupled to the signal pad, a source terminal, and a gate terminal coupled to the drain terminal of the first MOS transistor. The second MOS transistor has a drain terminal coupled to the signal pad, a source terminal coupled to the source terminal of the first MOS transistor, and a gate terminal coupled to receive the first impedance tuning signal. The first driver units are coupled in parallel between a first supply voltage and the source terminal of the first MOS transistor.

### BACKGROUND

### Technical Field

The disclosure generally relates to a driver and a chip, and more particularly, to an off-chip driver and a memory driver.

In memory chips, it is important to make output impedance, including output resistance and capacitance, on the input/output signal pads can follow system specification.

### SUMMARY

Accordingly, the disclosure is directed to an off-chip driver and a memory driver capable of providing an output impedance meeting specification.

The off-chip driver (OCD) of the present disclosure comprises a first driver circuit. The first driver circuit comprises a first impedance circuit and a plurality of first driver units. The first impedance circuit is coupled to a signal pad and controlled by a first impedance tuning signal. The first impedance circuit comprises a first metal-oxide-silicon (MOS) transistor and a second MOS transistor. The first MOS transistor has a drain terminal, a source terminal, and a gate terminal. The drain terminal of the first MOS transistor is coupled to the signal pad. The gate terminal of the first MOS transistor is coupled to the drain terminal of the first MOS transistor. The second MOS transistor has a drain terminal coupled to the signal pad, a source terminal coupled to the source terminal of the first MOS transistor, and a gate terminal coupled to receive the first impedance tuning signal. The first driver units are coupled in parallel between a first supply voltage and the source terminal of the first MOS transistor. The first driver units are controlled by a plurality of first driver signals to drive the signal pad to a first predetermined voltage level.

The memory chip of the present disclosure comprises an OCD. The OCD comprises a first driver circuit. The first driver circuit comprises a first impedance circuit and a plurality of first driver units. The first impedance circuit is coupled to a signal pad and controlled by a first impedance tuning signal. The first impedance circuit comprises a first metal-oxide-silicon (MOS) transistor and a second MOS transistor. The first MOS transistor has a drain terminal, a source terminal, and a gate terminal. The drain terminal of the first MOS transistor is coupled to the signal pad. The gate terminal of the first MOS transistor is coupled to the drain terminal of the first MOS transistor. The second MOS transistor has a drain terminal coupled to the signal pad, a source terminal coupled to the source terminal of the first MOS transistor, and a gate terminal coupled to receive the first impedance tuning signal. The first driver units are coupled in parallel between a first supply voltage and the source terminal of the first MOS transistor. The first driver units are controlled by a plurality of first driver signals to drive the signal pad to a first predetermined voltage level.

To make the aforementioned more comprehensible, several embodiments accompanied with drawings are described in detail as follows.

### BRIEF DESCRIPTION OF THE DRAWINGS

The accompanying drawings are included to provide a further understanding of the disclosure, and are incorporated in and constitute a part of this specification. The drawings illustrate exemplary embodiments of the disclosure and, together with the description, serve to explain the principles of the disclosure.

FIG. 1 illustrates a schematic diagram of a memory chip in accordance with some embodiments of the present disclosure.

FIG. 2 illustrates a schematic diagram of a first driver circuit in FIG. 1 in accordance with some embodiments of the present disclosure.

FIGS. 3A-3D illustrate schematic diagrams of first driver units in accordance with some embodiments of the present disclosure.

FIG. 4A illustrates a schematic diagram of a first impedance circuit in FIG. 2 in accordance with some embodiments of the present disclosure.

FIG. 4B illustrates a diagram of waveforms of the first impedance circuit in FIG. 4A in accordance with some embodiments of the present disclosure.

FIGS. 5-10 illustrates schematic diagrams of first driver circuits in accordance with some embodiments of the present disclosure.

FIG. 11 illustrates a schematic diagram of a second driver circuit in FIG. 1 in accordance with some embodiments of the present disclosure.

FIGS. 12A-12D illustrate schematic diagrams of second driver units in accordance with some embodiments of the present disclosure.

FIG. 13A illustrates a schematic diagram of a second impedance circuit in FIG. 11 in accordance with some embodiments of the present disclosure.

FIG. 13B illustrates a diagram of waveforms of the second impedance circuit in FIG. 13A in accordance with some embodiments of the present disclosure.

FIGS. 14-19 illustrates schematic diagrams of second driver circuits in accordance with some embodiments of the present disclosure.

### DESCRIPTION OF THE EMBODIMENTS

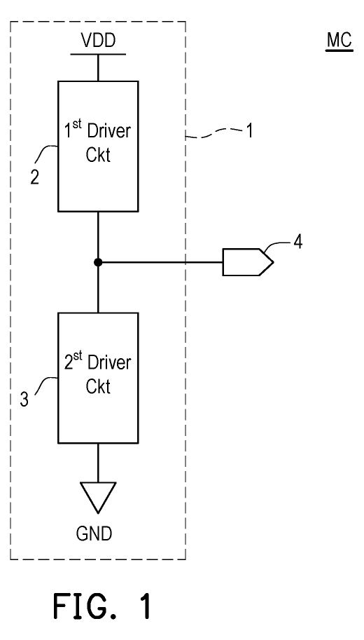

FIG. 1 illustrates a schematic diagram of a memory chip MC in accordance with some embodiments of the present disclosure. The memory chip MC includes an off-chip driver (OCD) 1 and a signal pad 4. For example, the memory chip MC may be a Double Data Rate (DDR) RAM memory chip that implement DDR interfacing scheme for high-speed data transfer. The signal pad 4 may be a pad queue pad used for data transmission.

The OCD 1 includes a first driver circuit 2 and a second driver circuit 3 coupled in series between a first supply voltage VDD and a second supply voltage GND. A node between the first driver circuit 2 and a second driver circuit 3 in the OCD 1 is coupled to the signal pad 4. Although not clearly illustrated, the OCD 1 may be coupled between a memory and the signal pad 4 for accessing data stored in the memory. The first driver circuit 2 is configured to pull up a voltage on the signal pad 4 to a predetermined high voltage level, and the second driver circuit 3 is configured to pull down the voltage on the signal pad 4 to a predetermined low voltage level.

In some embodiments, an output impedance including an output capacitance and an output resistance of the OCD 1 is required to be within respective specific ranges to meet design requirements.

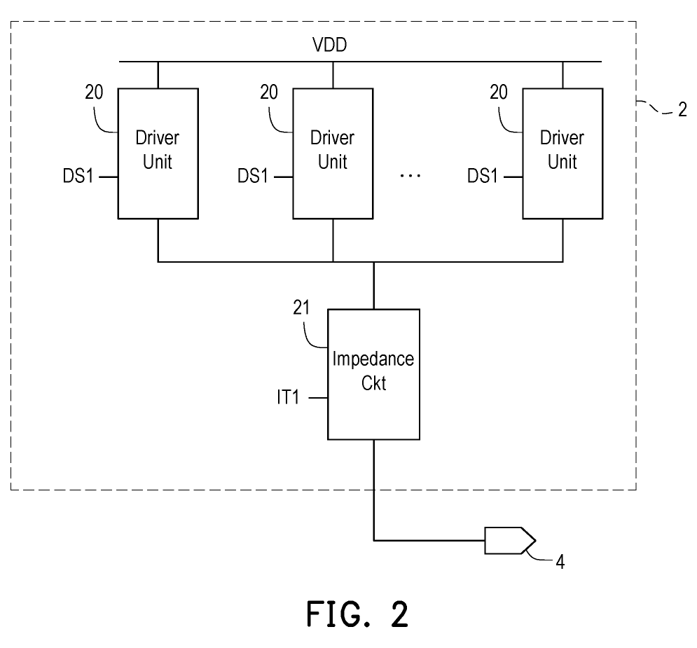

FIG. 2 illustrates a schematic diagram of a first driver circuit 2 in FIG. 1 in accordance with some embodiments of the present disclosure. The first driver circuit 2 includes a first impedance circuit 21 and a plurality of first driver units 20. The first impedance circuit 21 is coupled to the signal pad 4 and controlled by a first impedance tuning signal IT1. The plurality of first driver units 20 are coupled in parallel between a first supply voltage VDD and the first impedance circuit 21. The first driver units 20 are controlled by a plurality of first driver signals DS1 to drive the signal pad 4 to the predetermined high voltage level.

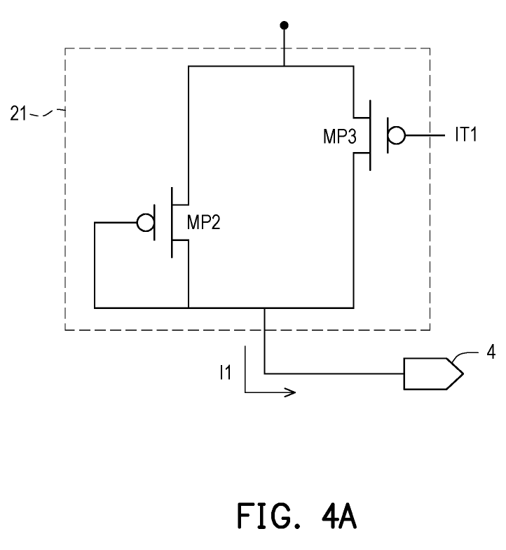

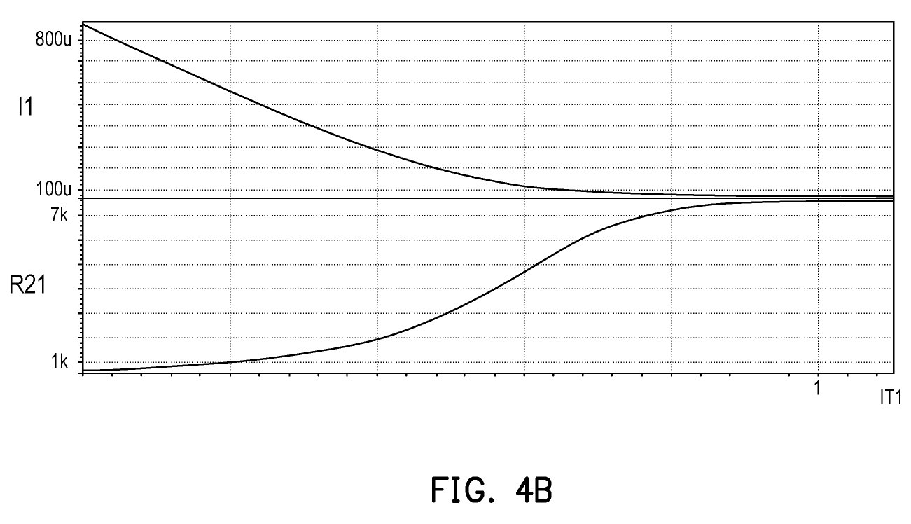

Specifically, the first driver signal DS1 is generated according to a data read from the memory and processed by appropriate algorithms. Based on the first driver signals DS1, part or all of the driver units 20 are turned on to drive the signal pad 4 to the predetermine high voltage level. Further, a number of first driver units 20 turned on by the first driver signals DS1 is affecting the output impedance seen from the signal pad 4. More particularly, the output resistance may be course tuned by the first driver signals DS1 for controlling a number of the first driver units 20 that are turned on. However, the parasitic capacitance of the first driver units 20 is unaffected whether the first driver units 20 are turned on or cutoff. With more of the first driver units 20, a greater output resistance tunable range may be obtained but it also leads to the greater parasitic capacitance. In order to meet the output resistance requirements to the OCD 1, the first impedance circuit 21 is added between the first driver units 20 and the signal pad 4 to isolate parasitic capacitance of the first driver units 20 from the signal pad 4. The first impedance circuit 21 will be described with greater details in the following paragraphs in relation to FIGS. 4A, 4B and is omitted herein.

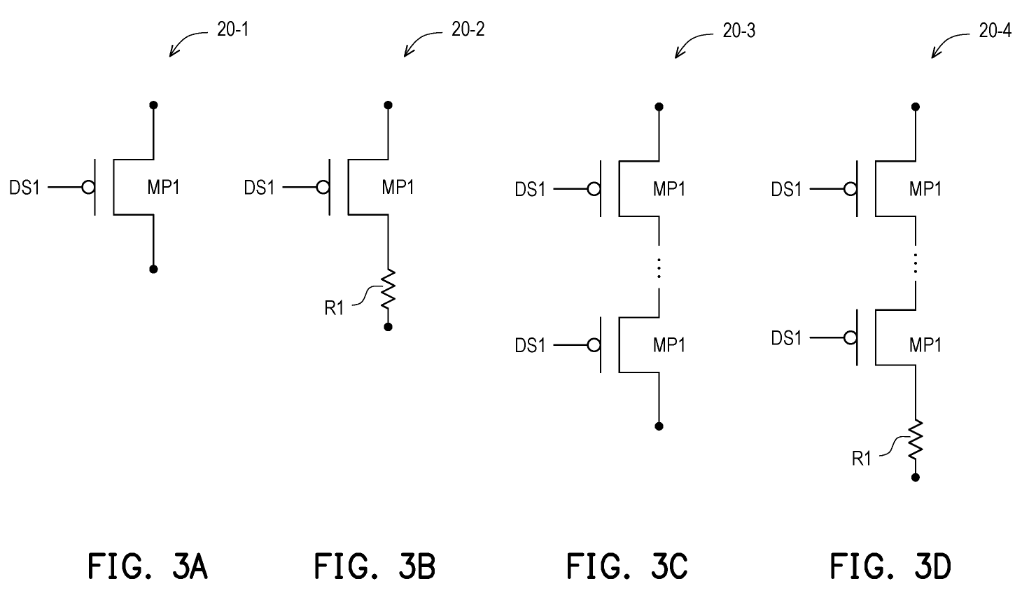

FIGS. 3A-3D illustrate schematic diagrams of first driver units 20-1 to 20-4 in accordance with some embodiments of the present disclosure. Each of the first driver units 20-1 to 20-4 may be used to replace the first driver unit 20 in FIG. 2.

As can be seen in FIG. 3A, the first driver unit 20-1 includes a P-type metal-oxide-silicon (PMOS) transistor MP1. Although not clearly illustrated, a drain terminal of the PMOS transistor MP1 may be coupled to the first impedance circuit 21, a source terminal of the PMOS transistor MP1 may be coupled to receive the first supply voltage VDD, and a gate terminal of the PMOS transistor MP1 may be coupled to receive the first driver signal DS1.

As can be seen in FIG. 3B, the first driver unit 20-2 includes a P-type metal-oxide-silicon (PMOS) transistor MP1 and a resistor R1. The resistor R1 and the PMOS transistor MP1 are coupled in series. Although not clearly illustrated, the resistor R1 and the PMOS transistor MP1 are coupled in series between the first supply voltage VDD and the first impedance circuit 21. More particularly, a source terminal of the PMOS transistor MP1 may be coupled to receive the first supply voltage VDD and a gate terminal of the PMOS transistor MP1 may be coupled to receive the first driver signal DS1. One end of the resistor R1 is coupled to a drain terminal of the PMOS transistor MP1 and another end of the resistor R1 is coupled to the impedance circuit 21.

As can be seen in FIG. 3C, the first driver unit 20-3 includes a plurality of P-type metal-oxide-silicon (PMOS) transistors MP1. The PMOS transistors MP1 are coupled in series as a string between the first supply voltage VDD and the first impedance circuit 21. Although not clearly illustrated, a source terminal of the topmost PMOS transistor MP1 in the string is coupled to receive the first supply voltage VDD and a drain terminal of the bottommost PMOS transistor MP1 in the string may be coupled to the first impedance circuit 21.

As can be seen in FIG. 3D, the first driver unit 20-4 includes a plurality of P-type metal-oxide-silicon (PMOS) transistors MP1 and a resistor R1. The PMOS transistors MP1 and the resistor R1 are coupled in series as a string between the first supply voltage VDD and the first impedance circuit 21. Although not clearly illustrated, a source terminal of the topmost PMOS transistor MP1 in the string is coupled to receive the first supply voltage VDD. A drain terminal of the bottommost PMOS transistor MP1 in the string may be coupled to one end of the resistor R1, and another end of the resistor R1 may be coupled to the first impedance circuit 21.

FIG. 4A illustrates a schematic diagram of a first impedance circuit 21 in FIG. 2 in accordance with some embodiments of the present disclosure. The first impedance circuit 21 is coupled between the first driver units 20 and the signal pad 4.

Specifically, the first impedance circuit 21 includes PMOS transistors MP2 and MP3 coupled in parallel. The PMOS transistor MP2 has a drain terminal coupled to the signal pad 4, a source terminal coupled to the first driver units 20, and a gate terminal coupled to the drain terminal of the PMOS transistor MP2. The PMOS transistor MP3 has a drain terminal coupled to the signal pad 4, a source terminal coupled to the source terminal of the PMOS transistor MP2, and a gate terminal coupled to receive the first impedance tuning signal IT1.

The first impedance circuit 21 is configured to isolate parasitic capacitance of the first driver units 20 from the signal pad 4 and provide an appropriate output capacitance to the signal pad 4. The output capacitance of the first driver circuit 2 are determined by parasitic capacitance at drain terminals of the PMOS transistors MP2 and MP3. The PMOS transistors MP2 and MP3 of the first impedance circuit 21 may provide stable output capacitance of the first driver circuit 2.

FIG. 4B illustrates a diagram of waveforms of the first impedance circuit 21 in FIG. 4A in accordance with some embodiments of the present disclosure.

It is shown in upper part of FIG. 4B that how the current I1 is changed with respect to the first impedance tuning signal IT1. As can be seen, the current I1 flowing through the first impedance circuit 21, including the PMOS transistors MP2 and MP3, decreases as the first impedance tuning signal IT1 applied to the gate terminal of the PMOS transistor MP3 increases.

Meanwhile, FIG. 4B in lower part shows that how the equivalent resistance R21 of the first impedance circuit 21 is changed with respect to the first impedance tuning signal IT1. As can be seen, the equivalent resistance R21 of the first impedance circuit 21 increases as the first impedance tuning signal IT1 applied to the gate terminal of the PMOS transistor MP3 increases. In other words, the equivalent resistance R21 varying with the first impedance tuning signal IT1 provides the first driver circuit 2 a wide and flexible tuning range of the output impedance. Besides, the first impedance circuit 21 may also isolate parasitic capacitance of the first driver units 20 from the signal pad 4, providing easier design complexity and simpler system compatibility.

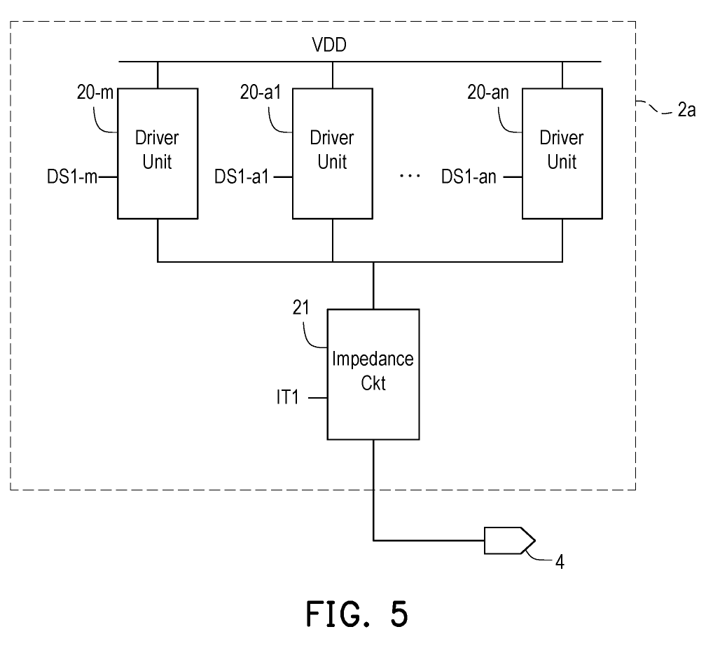

FIG. 5 illustrates a schematic diagram of a first driver circuit 2a in accordance with some embodiments of the present disclosure. The first driver circuit 2a in FIG. 5 is similar to the first driver circuit 2 in FIG. 2 and may also be applied in the OCD 1 in FIG. 1.

In this embodiment, in addition to the first driver units 20-a1 to 20-an, the first driver circuit 2a further includes a second driver unit 20-m. The second driver unit 20-m is controlled by a second driver signal DS1-m, and the first driver units 20-a1 to 20-an are controlled by a plurality of first driver signals DS1-a1 to DS1-an. The second driver unit 20-m may serve as a main driver unit for driving the signal pad 4 to the predetermined high voltage level. Part or all of the first driver units 20-a1 to 20-an are selected by the activated first driver signals DS1-a1 to DS1-an to serve as an auxiliary current source in assisting driving the signal pad 4 to the predetermined high voltage level while controlling the output resistance of the first driver circuit 2a within the predetermined resistance range.

Further, the first impedance circuit 21 isolates the parasitic capacitance of the second driver unit 20-m and the first driver units 20-a1 to 20-an from the signal pad 4 and provides stable output capacitance of the first driver circuit 2a.

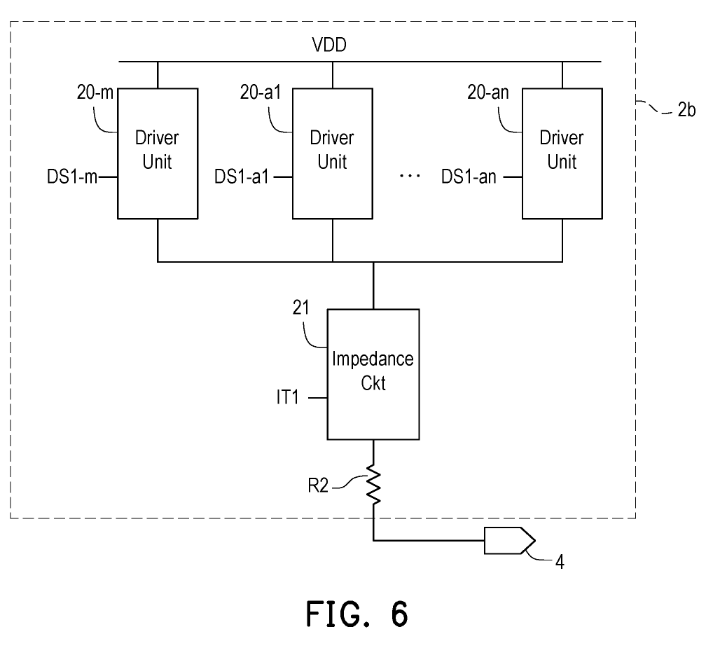

FIG. 6 illustrates a schematic diagram of a first driver circuit 2b in accordance with some embodiments of the present disclosure. The first driver circuit 2b in FIG. 6 is similar to the first driver circuit 2a in FIG. 5 and may also be applied in the OCD 1 in FIG. 1.

Similar to the first driver circuit 2a, the first driver circuit 2b includes first driver units 20-a1 to 20-an and a second driver unit 20-m. The second driver unit 20-m is controlled by a second driver signal DS1-m, and the first driver units 20-a1 to 20-an are controlled by a plurality of first driver signals DS1-a1 to DS1-an. The second driver unit 20-m serves as a main current source of driving the signal pad 4 to the predetermined high voltage level. Part or all of the first driver units 20-a1 to 20-an are selected by the activated first driver signals DS1-a1 to DS1-an to serve as an auxiliary current source in assisting to drive the signal pad 4 to the predetermined high voltage level while controlling the output resistance of the first driver circuit 2b within the predetermined resistance range.

Further, a resistor R2 is added between the first impedance circuit 21 and the signal pad 4. The resistor R2 can provide a great portion of the required resistance, so that sizes of the first driver units may be reduced.

The first impedance circuit 21 isolates the parasitic capacitance of the second driver unit 20-m and the first driver units 20-a1 to 20-an from the signal pad 4 and provides stable output capacitance of the first driver circuit 2b.

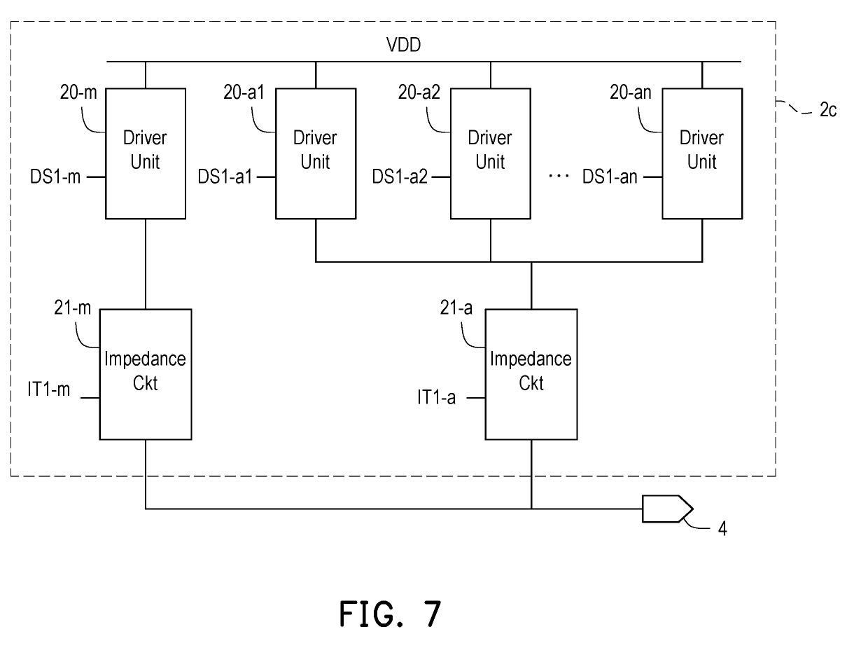

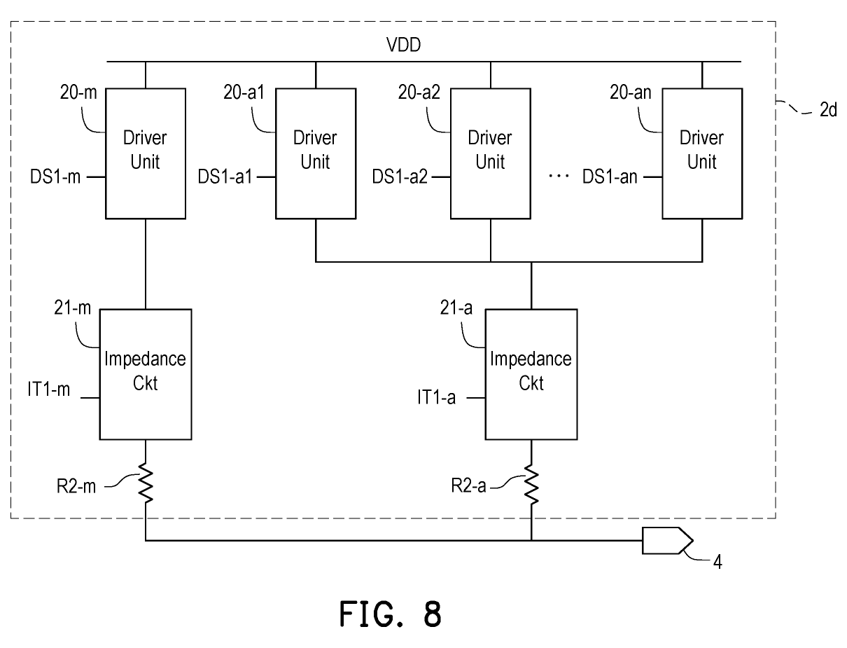

FIG. 7 illustrates a schematic diagram of a first driver circuit 2c in accordance with some embodiments of the present disclosure. The first driver circuit 2c in FIG. 7 is similar to the first driver circuit 2a in FIG. 5 and may also be applied in the OCD 1 in FIG. 1.

Similar to the first driver circuit 2a, the first driver circuit 2c includes a plurality of first driver units 20-a1 to 20-an and a second driver unit 20-m. The second driver unit 20-m is controlled by a second driver signal DS1-m, and the first driver units 20-a1 to 20-an are controlled by a plurality of first driver signals DS1-a1 to DS1-an. In FIG. 6 the second driver unit 20-m and the first driver units 20-a1 to 20-an share the same first impedance circuit 21, but in FIG. 7 the second driver unit 20-m and the first driver units 20-a1 to 20-an are controlled by separated impedance circuits. In this embodiment however, in addition to the first impedance circuit 21-a controlled by the first impedance tuning signal IT1-a, the first driver circuit 2c further includes a second impedance circuit 21-m. The second impedance circuit 21-m is coupled between the second driver unit 20-m and the signal pad 4. The first impedance circuit 21-a is coupled between the first driver units 20-a1 to 20-an and the signal pad 4 and controlled by a second impedance tuning signal IT1-a.

Both of the second impedance circuit 21-m and the first impedance circuit 21-a are capable of isolating parasitic capacitance of the second driver unit 20-m and the first driver units 20-a1 to 20-an from the signal pad 4 and providing stable output capacitance of the first driver circuit 2c.

In some embodiments, the first impedance tuning signal IT1-a and the second impedance tuning signal IT1-m may be at the same voltage level, or at different voltage levels. The first impedance tuning signal IT1-a and the second impedance tuning signal IT1-m being at the same voltage level provides an easier design complexity to the first driver circuit 2c. On the other hand, the first impedance tuning signal IT1-a and the second impedance tuning signal IT1-m being at different voltage levels improves a precision of the output impedance of the first driver circuit 2c.

FIG. 8 illustrates a schematic diagram of a first driver circuit 2d in accordance with some embodiments of the present disclosure. The first driver circuit 2d in FIG. 8 is similar to the first driver circuit 2c in FIG. 7 and may also be applied in the OCD 1 in FIG. 1.

In this embodiment, the first driver circuit 2d further includes resistors R2-m and R2-a. The resistor R2-m is coupled between the second impedance circuit 21-m and the signal pad 4, and the resistor R2-a is coupled between the first impedance circuit 21-a and the signal pad 4. The resistors R2-m and R2-a can provide a great portion of the required resistance, so that sizes of the first driver units may be reduced.

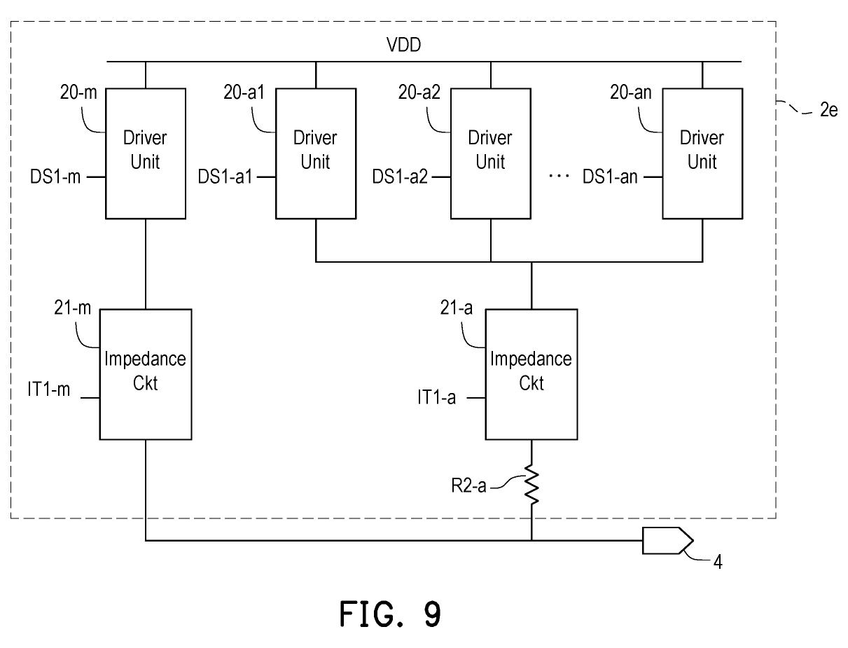

FIG. 9 illustrates a schematic diagram of a first driver circuit 2e in accordance with some embodiments of the present disclosure. The first driver circuit 2e in FIG. 9 is similar to the first driver circuit 2d in FIG. 8 and may also be applied in the OCD 1 in FIG. 1.

In this embodiment, the first driver circuit 2e only includes one resistor R2-a coupled between the first impedance circuit 21-a and the signal pad 4. The resistor R2-a can provide a great portion of the required resistance, so that sizes of the first driver units 20-a1 to 20-an may be reduced.

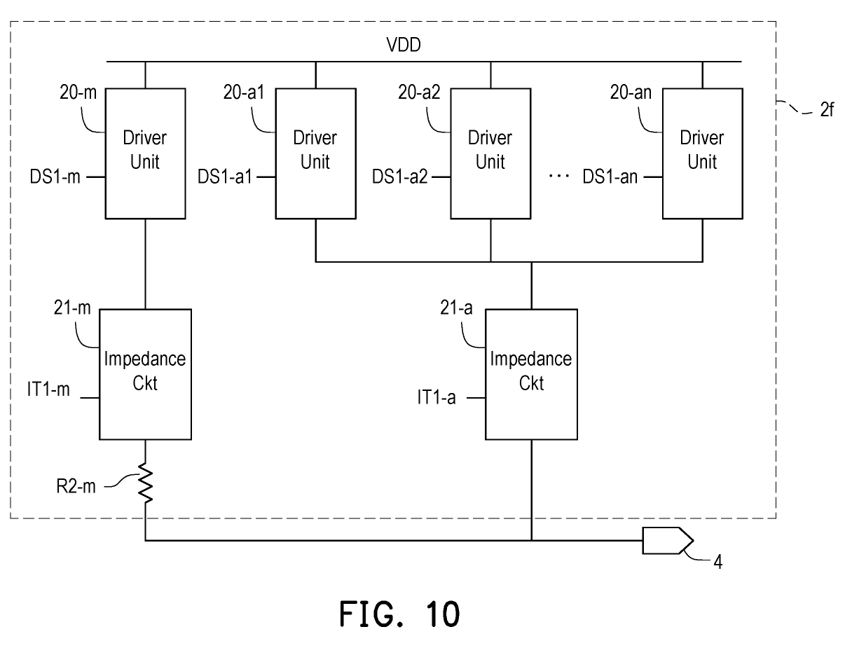

FIG. 10 illustrates a schematic diagram of a first driver circuit 2f in accordance with some embodiments of the present disclosure. The first driver circuit 2f in FIG. 10 is similar to the first driver circuit 2d in FIG. 8 and may also be applied in the OCD 1 in FIG. 1.

In this embodiment, the first driver circuit 2f only includes one resistor R2-m coupled between the second impedance circuit 21-m and the signal pad 4. The resistor R2-m can provide a great portion of the required resistance, so that size of the second driver unit 20-m may be reduced.

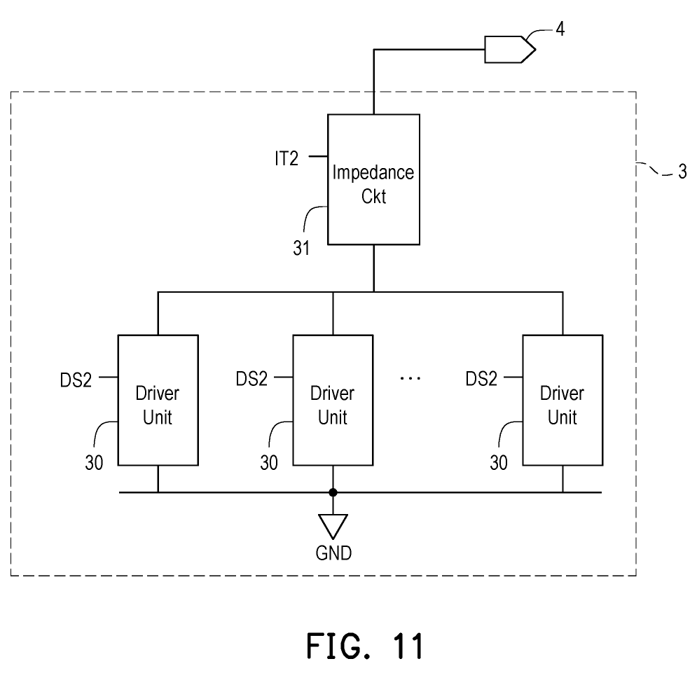

FIG. 11 illustrates a schematic diagram of a second driver circuit 3 in FIG. 1 in accordance with some embodiments of the present disclosure. The second driver circuit 3 includes a second impedance circuit 31 and a plurality of second driver units 30. The second impedance circuit 31 is coupled to the signal pad 4 and controlled by a third impedance tuning signal IT2. The plurality of second driver units 30 are coupled in parallel between a second supply voltage GND and the second impedance circuit 31. The second driver units 30 are controlled by a plurality of third driver signals DS2 to drive the signal pad 4 to the predetermined low voltage level.

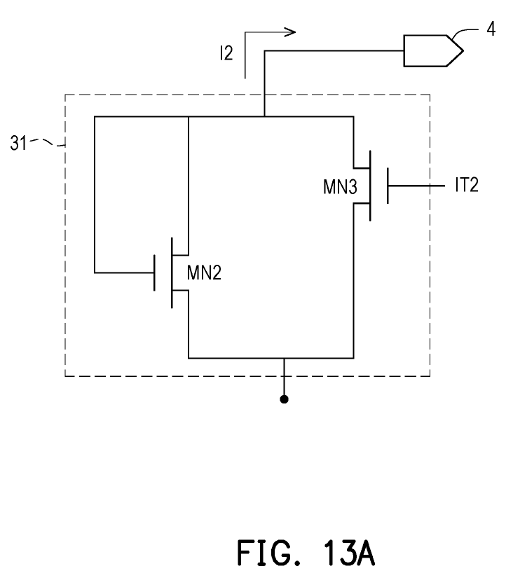

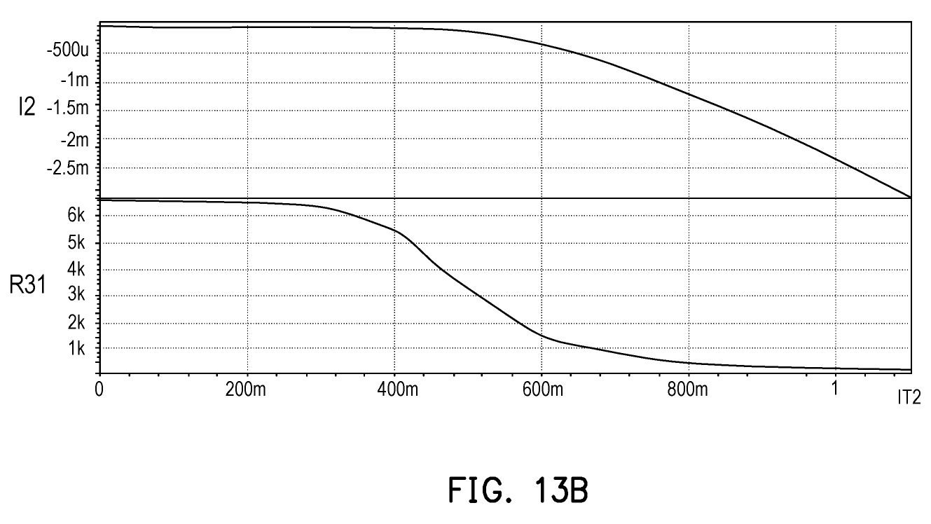

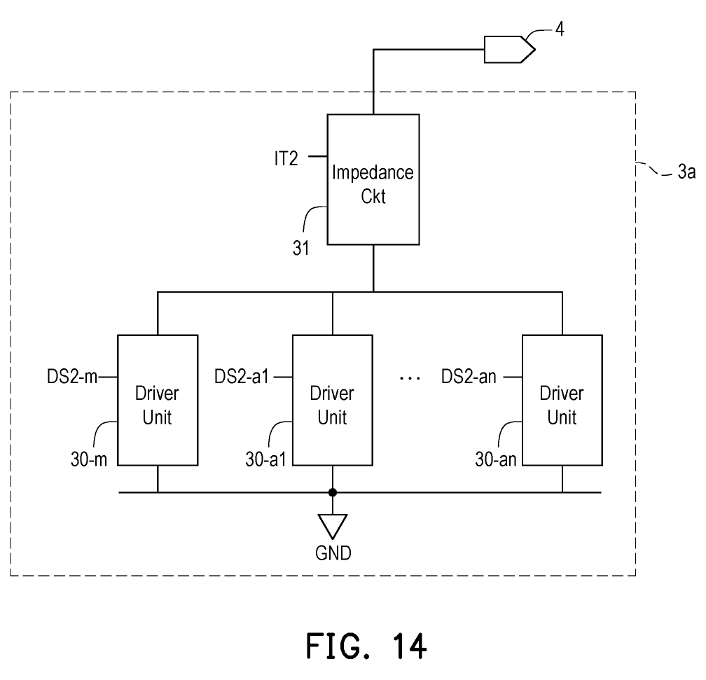

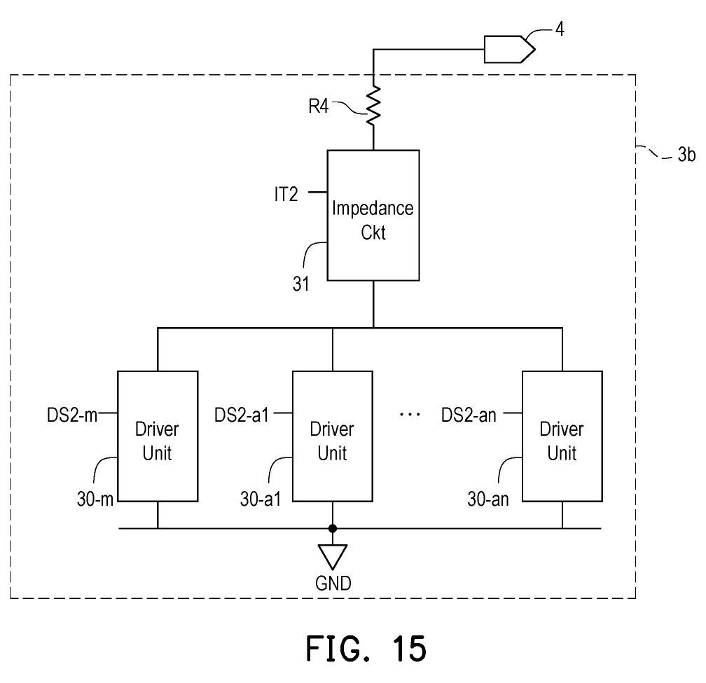

Specifically, the third driver signal DS2 is generated according to a data read from the memory and processed by appropriate algorithms. Based on the third driver signals DS2, part or all of the driver units 30 are turned on to drive the signal pad 4 to the predetermine low voltage level. Further, a number of second driver units 30 turned on by the third driver signals DS2 is affecting the output impedance seen from the signal pad 4. More particularly, the output resistance may be course tuned by the third driver signals DS2 for controlling a number of the second driver units 30 that are turned on. However, the parasitic capacitance of the second driver units 30 is unchanged whether the second driver units 30 are turned on or cutoff. With more of the second driver units 30, a greater output resistance tunable range may be obtained but it also leads to the greater parasitic capacitance. In order to meet the output resistance requirements to the OCD 1, the second impedance circuit 31 is added between the second driver units 30 and the signal pad 4 to isolate the parasitic capacitance of the second driver units 30 from the signal pad 4. The second impedance circuit 31 will be described with greater details in the following paragraphs in relation to FIGS. 13A, 13B and is omitted herein.

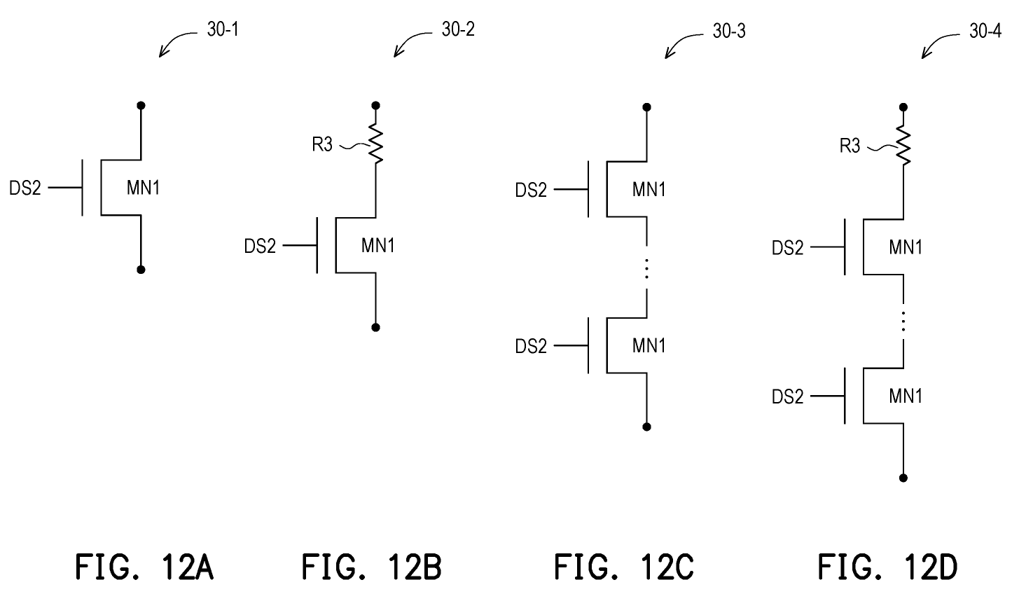

FIGS. 12A-12D illustrates schematic diagrams of third driver units 30-1 to 30-4 in accordance with some embodiments of the present disclosure. Each of the third driver units 30-1 to 30-4 may be used to replace the third driver unit 30 in FIG. 11.

As can be seen in FIG. 12A, the third driver unit 30-1 includes a N-type metal-oxide-silicon (NMOS) transistor MN1. Although not clearly illustrated, a drain terminal of the NMOS transistor MN1 may be coupled to the third impedance circuit 31, a source terminal of the NMOS transistor MN1 may be coupled to receive the second supply voltage GND, and a gate terminal of the NMOS transistor MN1 may be coupled to receive the third driver signal DS2.

As can be seen in FIG. 12B, the third driver unit 30-2 includes an NMOS transistor MN1 and a resistor R3. The resistor R3 and the NMOS transistor MN1 are coupled in series. Although not clearly illustrated, the resistor R3 and the NMOS transistor MN1 are coupled in series between the second supply voltage GND and the third impedance circuit 31. More particularly, a source terminal of the NMOS transistor MN1 may be coupled to receive the second supply voltage GND and a gate terminal of the NMOS transistor MN1 may be coupled to receive the third driver signal DS2. One end of the resistor R3 is coupled to a drain terminal of the NMOS transistor MN1 and another end of the resistor R3 is coupled to the impedance circuit 31.

As can be seen in FIG. 12C, the third driver unit 30-3 includes a plurality of NMOS transistors MN1. The NMOS transistors MN1 are coupled in series as a string between the second supply voltage GND and the third impedance circuit 31. Although not clearly illustrated, a source terminal of the bottommost NMOS transistor MN1 in the string is coupled to receive the second supply voltage GND and a drain terminal of the topmost NMOS transistor MN1 in the string may be coupled to the third impedance circuit 31.

As can be seen in FIG. 12D, the third driver unit 30-4 includes a plurality of NMOS transistors MN1 and a resistor R3. The NMOS transistors MN1 and the resistor R3 are coupled in series as a string between the second supply voltage GND and the third impedance circuit 31. Although not clearly illustrated, a source terminal of the bottommost NMOS transistor MN1 in the string is coupled to receive the second supply voltage GND. A drain terminal of the topmost NMOS transistor MN1 in the string may be coupled to one end of the resistor R3, and another end of the resistor R3 may be coupled to the third impedance circuit 31.

FIG. 13A illustrates a schematic diagram of a third impedance circuit 31 in FIG. 11 in accordance with some embodiments of the present disclosure. The third impedance circuit 31 is coupled between the third driver units 30 and the signal pad 4.

Specifically, the third impedance circuit 31 includes NMOS transistors MN2 and MN3 coupled in parallel. The NMOS transistor MN2 has a drain terminal coupled to the signal pad 4, a source terminal coupled to the third driver units 30, and a gate terminal coupled to the drain terminal of the NMOS transistor MN2. The NMOS transistor MN3 has a drain terminal coupled to the signal pad 4, a source terminal coupled to the source terminal of the NMOS transistor MN2, and a gate terminal coupled to receive the third impedance tuning signal IT2.

The third impedance circuit 31 is configured to isolate parasitic capacitance of the third driver units 30 from the signal pad 4 and provide an appropriate output capacitance to the signal pad 4. The output capacitance of the second driver circuit 3 are determined by parasitic capacitance at drain terminals of the NMOS transistors MN2 and MN3. The NMOS transistors MN2 and MN3 of the third impedance circuit 31 may provide stable output capacitance of the second driver circuit 3.

FIG. 13B illustrates a diagram of waveforms of the third impedance circuit 31 in FIG. 13A in accordance with some embodiments of the present disclosure.

It is shown in upper part of FIG. 13B that how the current I2 is changed with respect to the third impedance tuning signal IT2. As can be seen, the current I2 flowing through the third impedance circuit 31, including the NMOS transistors MN2 and MN3, decreases as the third impedance tuning signal IT2 applied to the gate terminal of the NMOS transistor MN3 increases.

Meanwhile, FIG. 13B in lower part shows that how the equivalent resistance R31 of the third impedance circuit 31 is changed with respect to the third impedance tuning signal IT2. As can be seen, the equivalent resistance R31 of the third impedance circuit 31 decrease as the third impedance tuning signal IT2 applied to the gate terminal of the NMOS transistor MN3 increases. In other words, the equivalent resistance R31 varying with the third impedance tuning signal IT2 provides the first driver circuit 2 a wide and flexible tuning range of the output impedance. Besides, the third impedance circuit 31 may also isolate parasitic capacitance of the third driver units 30 from the signal pad 4, providing easier design complexity and simpler system compatibility.

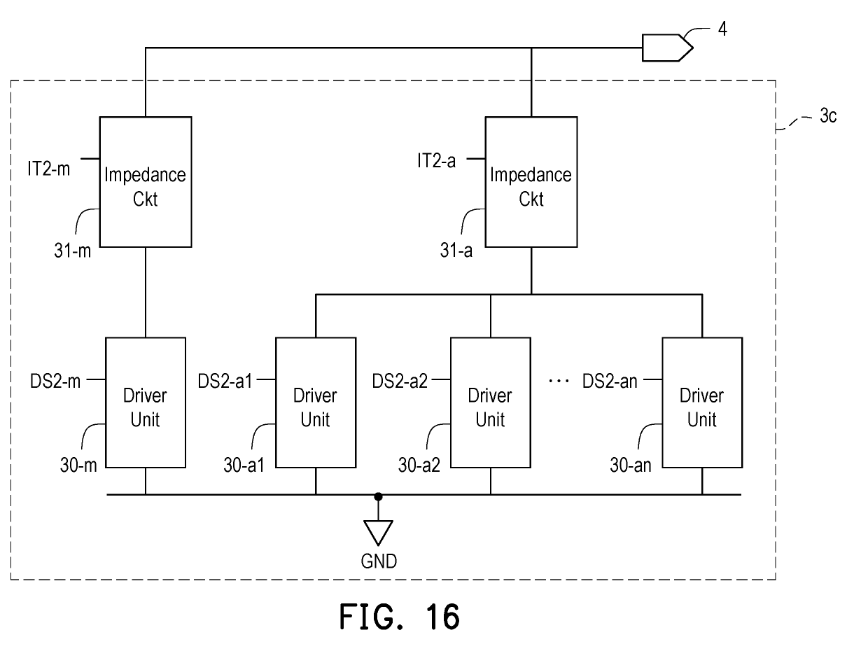

FIG. 14 illustrates a schematic diagram of a second driver circuit 3a in accordance with some embodiments of the present disclosure. The second driver circuit 3a in FIG. 14 is similar to the second driver circuit 3 in FIG. 11 and may also be applied in the OCD 1 in FIG. 1.

In this embodiment, in addition to the third driver units 30-a1 to 30-an, the second driver circuit 3a further includes a fourth driver unit 30-m. The fourth driver unit 30-m is controlled by a fourth driver signal DS2-m, and the third driver units 30-a1 to 30-an are controlled by a plurality of third driver signals DS2-a1 to DS2-an. The fourth driver unit 30-m may serve as a main current source for driving the signal pad 4 to the predetermined low voltage level. Part or all of the third driver units 30-a1 to 30-an are selected by the activated third driver signals DS2-a1 to DS2-an to serve as an auxiliary current source in assisting driving the signal pad 4 to the predetermined low voltage level while controlling the output resistance of the second driver circuit 3a within the predetermined resistance range.

Further, the third impedance circuit 31 isolates the parasitic capacitance of the fourth driver unit 30-m and the third driver units 30-a1 to 30-an from the signal pad 4 and provides stable output capacitance of the second driver circuit 3a.

FIG. 15 illustrates a schematic diagram of a second driver circuit 3b in accordance with some embodiments of the present disclosure. The second driver circuit 3b in FIG. 15 is similar to the second driver circuit 3a in FIG. 14 and may also be applied in the OCD 1 in FIG. 1.

Similar to the second driver circuit 3a, the second driver circuit 3b includes third driver units 30-a1 to 30-an and a fourth driver unit 30-m. The fourth driver unit 30-m is controlled by a fourth driver signal DS2-m, and the third driver units 30-a1 to 30-an are controlled by a plurality of third driver signals DS2-a1 to DS2-an. The fourth driver unit 30-m serves as a main current source of driving the signal pad 4 to the predetermined low voltage level. Part or all of the third driver units 30-a1 to 30-an are selected by the activated third driver signals DS2-a1 to DS2-an to serve as an auxiliary current source in assisting to drive the signal pad 4 to the predetermined low voltage level while controlling the output resistance of the second driver circuit 3b within the predetermined resistance range.

Further, a resistor R4 is added between the third impedance circuit 31 and the signal pad 4. The resistor R4 can provide a great portion of the required resistance, so that sizes of the third driver units 30-a1 to 30-an and the fourth driver unit 30-m may be reduced.

The third impedance circuit 31 isolates the parasitic capacitance of the fourth driver unit 30-m and the third driver units 30-a1 to 30-an from the signal pad 4 and provides stable output capacitance of the second driver circuit 3b.

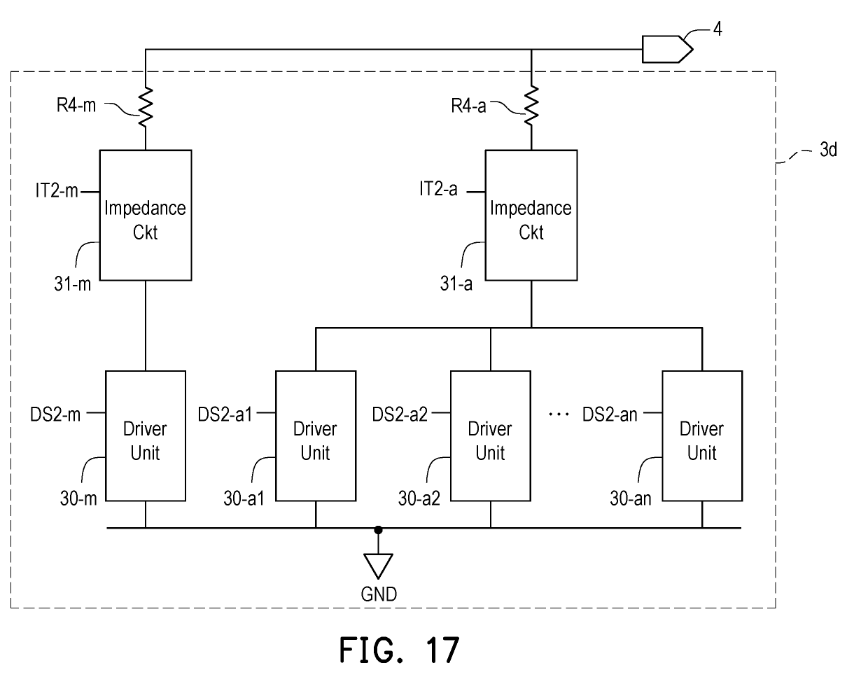

FIG. 16 illustrates a schematic diagram of a second driver circuit 3c in accordance with some embodiments of the present disclosure. The second driver circuit 3c in FIG. 16 is similar to the second driver circuit 3a in FIG. 14 and may also be applied in the OCD 1 in FIG. 1.

Similar to the second driver circuit 3a, the second driver circuit 3c includes a plurality of third driver units 30-a1 to 30-an and a fourth driver unit 30-m. The fourth driver unit 30-m is controlled by a fourth driver signal DS2-m, and the third driver units 30-a1 to 30-an are controlled by a plurality of third driver signals DS2-a1 to DS2-an. In FIG. 15 the fourth driver unit 30-m and the third driver units 30-a1 to 30-an share the same third impedance circuit 31, but in FIG. 16 the fourth driver unit 30-m and the third driver units 30-a1 to 30-an are controlled by separated impedance circuits. In this embodiment however, in addition to the third impedance circuit 31-a controlled by the third impedance tuning signal IT2-a, the second driver circuit 3c further includes a fourth impedance circuit 31-m. The fourth impedance circuit 31-m is coupled between the fourth driver unit 30-m and the signal pad 4. The third impedance circuit 31-a is coupled between the third driver units 30-a1 to 30-an and the signal pad 4 and controlled by a fourth impedance tuning signal IT2-m.

Both of the fourth impedance circuit 31-m and the third impedance circuit 31-a are capable of isolating parasitic capacitance of the fourth driver unit 30-m and the third driver units 30-a1 to 30-an from the signal pad 4 and providing stable output capacitance of the second driver circuit 3c.

In some embodiments, the third impedance tuning signal IT2-a and the fourth impedance tuning signal IT2-m may be at the same voltage level, or at different voltage levels. The third impedance tuning signal IT2-a and the fourth impedance tuning signal IT2-m being at the same voltage level provides an easier design complexity to the second driver circuit 3c. On the other hand, the third impedance tuning signal IT2-a and the fourth impedance tuning signal IT2-m being at different voltage levels improves a precision of the output impedance of the second driver circuit 3c.

FIG. 17 illustrates a schematic diagram of a second driver circuit 3d in accordance with some embodiments of the present disclosure. The second driver circuit 3d in FIG. 17 is similar to the second driver circuit 3b in FIG. 15 and may also be applied in the OCD 1 in FIG. 1.

In this embodiment, the second driver circuit 3d further includes resistors R4-m and R4-a. The resistor R4-m is coupled between the fourth impedance circuit 31-m and the signal pad 4, and the resistor R4-a is coupled between the third impedance circuit 31-a and the signal pad 4. The resistors R4-m and R4-a can provide a great portion of the required resistance, so that sizes of the third driver units may be reduced.

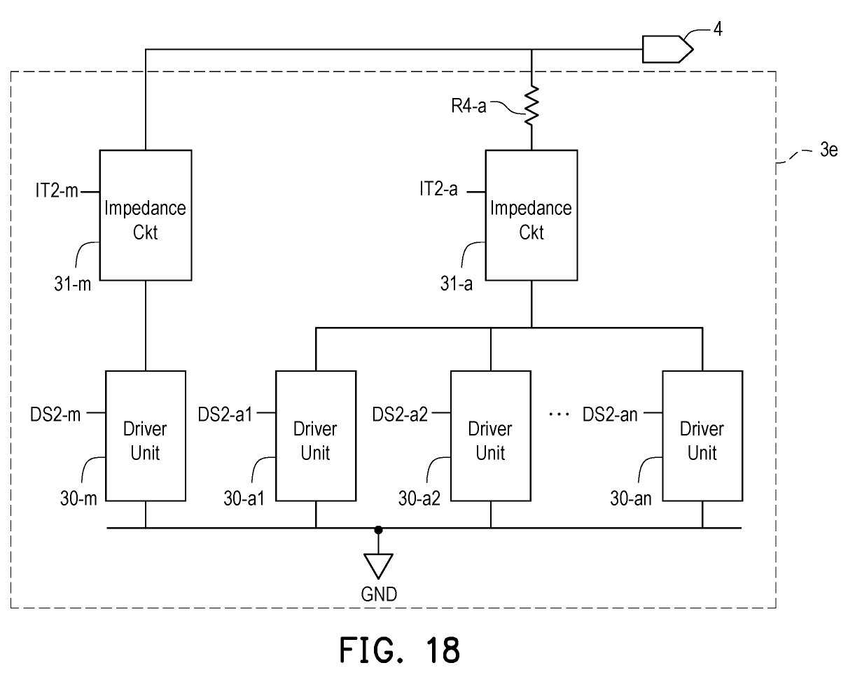

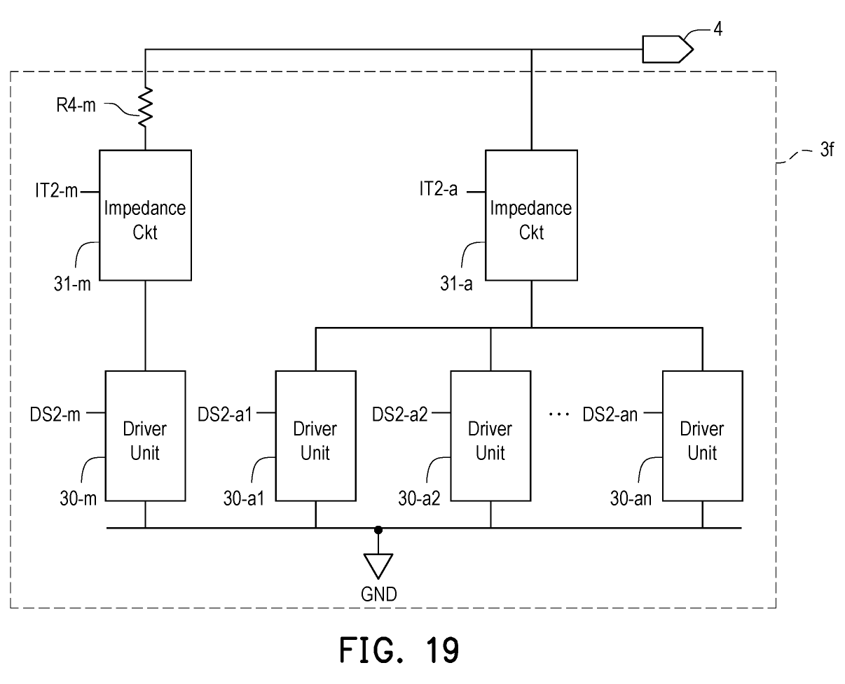

FIG. 18 illustrates a schematic diagram of a second driver circuit 3e in accordance with some embodiments of the present disclosure. The second driver circuit 3e in FIG. 18 is similar to the second driver circuit 3d in FIG. 17 and may also be applied in the OCD 1 in FIG. 1.

In this embodiment, the second driver circuit 3d only includes one resistor R4-a coupled between the third impedance circuit 31-a and the signal pad 4. The resistor R4-a can provide a great portion of the required resistance, so that sizes of the third driver units 30-a1 to 30-an may be reduced.

FIG. 19 illustrates a schematic diagram of a second driver circuit 3f in accordance with some embodiments of the present disclosure. The second driver circuit 3f in FIG. 19 is similar to the second driver circuit 3d in FIG. 17 and may also be applied in the OCD 1 in FIG. 1.

In this embodiment, the second driver circuit 3f only includes one resistor R4-m coupled between the fourth impedance circuit 31-m and the signal pad 4. The resistor R4-m can provide a great portion of the required resistance, so that size of the fourth driver unit 30-m may be reduced.

In summary, the OCD and the memory chip of the present disclosure is capable of providing a stable output capacitance to the signal pad while still providing a wide tunable output resistance range. Therefore, the OCD and the memory chip may effectively reduce design complexity and system compatibility.

It will be apparent to those skilled in the art that various modifications and variations can be made to the disclosed embodiments without departing from the scope or spirit of the disclosure. In view of the foregoing, it is intended that the disclosure covers modifications and variations provided that they fall within the scope of the following claims and their equivalents.

What is claimed is:

1. An off-chip driver (OCD), comprising:
a first driver circuit comprising:
a first impedance circuit coupled to a signal pad and controlled by a first impedance tuning signal, the first impedance circuit comprising:
a first metal-oxide-silicon (MOS) transistor having a drain terminal coupled to the signal pad, a source terminal, and a gate terminal coupled to the drain terminal of the first MOS transistor; and
a second MOS transistor having a drain terminal coupled to the signal pad, a source terminal coupled to the source terminal of the first MOS transistor, and a gate terminal coupled to receive the first impedance tuning signal; and
a plurality of first driver units coupled in parallel between a first supply voltage and the source terminal of the first MOS transistor, the plurality of first driver units being controlled by a plurality of first driver signals to drive the signal pad to a first predetermined voltage level.

2. The OCD of claim 1, wherein an equivalent resistance of the first impedance circuit is adjusted by a voltage level of the first impedance tuning signal.

3. The OCD of claim 1, wherein the first driver circuit further comprises a second driver unit, the plurality of first driver units and the second driver units are coupled in parallel between the first supply voltage and the first impedance circuit, the plurality of first driver units serving as a plurality of auxiliary driver units and the second driver unit serving as a main driver to drive the signal pad to the first predetermined voltage level.

4. The OCD of claim 1, wherein the first driver circuit further comprises a first resistor coupled between the signal pad and the first impedance circuit.

5. The OCD of claim 1, wherein the first driver circuit further comprises:
a second impedance circuit coupled to the signal pad and controlled by a second impedance tuning signal; and
a second driver unit coupled between the first supply voltage and the second impedance circuit, the second driver unit being controlled by a second driver signal to drive the signal pad to the first predetermine voltage level.

6. The OCD of claim 5, the first driver circuit further comprising a second resistor coupled between the second impedance circuit and the signal pad.

7. The OCD of claim 1, further comprising a second driver circuit coupled between the signal pad and a second supply voltage, the second driver circuit comprising:
a third impedance circuit coupled to the signal pad and controlled by a third impedance tuning signal, the third impedance circuit comprising:
a third MOS transistor having a drain terminal coupled to the signal pad, a source terminal, and a gate terminal coupled to the drain terminal of the first MOS transistor; and
a fourth MOS transistor having a drain terminal coupled to the signal pad, a source terminal coupled to the source terminal of the first MOS transistor, and a gate terminal coupled to receive the third impedance tuning signal; and
a plurality of third driver units coupled in parallel between the second supply voltage and the third impedance circuit, the plurality of third driver units being controlled by a plurality of third driver signals to drive the signal pad to a second predetermined voltage level.

8. The OCD of claim 7, wherein the first supply voltage is higher than the second supply voltage, the first predetermined voltage level is a predetermined high voltage level, the second predetermined voltage level is a predetermined low voltage level, all transistors in the first driver circuit are P-type MOS transistors, all transistors in the second driver circuit are N-type MOS transistors.

9. The OCD of claim 7, wherein an equivalent resistance of the third impedance circuit is adjusted by a voltage level of the third impedance tuning signal.

10. The OCD of claim 7, wherein the second driver circuit further comprises a fourth driver unit, the plurality of third driver units and the fourth driver unit are coupled in parallel between the second supply voltage and the third impedance circuit, the plurality of third driver units serving as a plurality of auxiliary driver units and the second driver unit serving as a main driver to drive the signal pad to the second predetermined voltage level.

11. The OCD of claim 7, the second driver circuit further comprising a third resistor coupled between the signal pad and the third impedance circuit.

12. The OCD of claim 7, wherein the second driver circuit further comprises:
a fourth impedance circuit coupled to the signal pad and controlled by a fourth impedance tuning signal; and
a fourth driver unit coupled between the second supply voltage and the fourth impedance circuit, the fourth driver unit being controlled by a fourth driver signal to drive the signal pad to the second predetermine voltage level.

13. The OCD of claim 12, wherein the second driver circuit further comprises a fourth resistor coupled between the fourth impedance circuit and the signal pad.

14. A memory chip, comprising:
an off-chip driver (OCD), comprising:
a first driver circuit comprising:
a first impedance circuit coupled to a signal pad and controlled by a first impedance tuning signal, the first impedance circuit comprising:
a first metal-oxide-silicon (MOS) transistor having a drain terminal coupled to the signal pad, a source terminal, and a gate terminal coupled to the drain terminal of the first MOS transistor; and
a second MOS transistor having a drain terminal coupled to the signal pad, a source terminal coupled to the source terminal of the first MOS transistor, and a gate terminal coupled to receive the first impedance tuning signal; and
a plurality of first driver units coupled in parallel between a first supply voltage and the source terminal of the first MOS transistor, the plurality of first driver units being controlled by a plurality of first driver signals to drive the signal pad to a first predetermined voltage level.
